(19) United States
(12) Patent Application Publication
(10) Pub. No.: US 2026/0276788 A1
(43) Pub. Date: Sep. 17, 2026

(54) LIDAR SYSTEM FOR VEHICLE

(71) Applicant: HYUNDAI MOBIS CO., LTD., Seoul (KR)

(72) Inventors: Jae Sup BYUN, Yongin-si (KR); Jang Ho KIM, Yongin-si (KR)

(73) Assignee: HYUNDAI MOBIS CO., LTD., Seoul (KR)

(21) Appl. No.: 19/058,264

(22) Filed: Feb. 20, 2025

(51) Int. Cl. G01S 7/481; B60R 11/02; E05F 15/63; G01S 17/931; B60R 11/00

(52) U.S. Cl. CPC G01S 7/4813; B60R 11/02; E05F 15/63; G01S 17/931; B60R 2011/004; B60R 2011/0084; B60R 2011/0092; B60R 2011/0094; E05Y 2201/638; E05Y 2201/686; E05Y 2900/53

(57) ABSTRACT

A lidar system for a vehicle, and a lidar device for a vehicle are provided. The lidar system includes a housing disposed behind a rear surface of a grill of the vehicle in which an opening is formed and having a shaft rotatably connected to an actuator, the housing including a guide groove, a guide hole, and a sliding rail, a door to move along the guide groove and the guide hole, and open and close the opening, a door link which rotates along with the shaft and transmits power from the actuator to the door, a lidar module which selectively operates to slide forward and backward along the sliding rail of the housing to be exposed to an outside through the opening, and a lidar loader connecting the shaft to the lidar module to deploy the lidar module according to rotation of the shaft.

### BACKGROUND

### 1. Field

The present invention relates to a lidar system for a vehicle, and more specifically, to a lidar system for a vehicle installed on a structure of the vehicle.

### 2. Description of the Related Art

With the development of vehicle technologies, functions such as autonomous driving and autonomous parking are required. A lidar is increasingly needed to perform these functions. In general, the lidar is mounted on a structure such as a bumper, grill, or the like of a vehicle to detect forward/rearward objects, structures, or the like around the vehicle.

However, since the lidar is mounted to be exposed to the outside of the vehicle, foreign substances such as dust or the like may be attached to a surface thereof while the vehicle is traveling. Accordingly, problems that the accuracy of measured values of the sensor decreases and a surrounding environment cannot be recognized occur. Therefore, there is a need to solve these problems.

### SUMMARY

The present disclosure seeks to provide solutions to solve the above-mentioned problems and aims to provide a lidar system for a vehicle, in which it is possible to prevent a lidar from being contaminated by deploying the lidar to the outside of the vehicle only when operation of the lidar is needed, such as traveling in an autonomous driving mode.

Objects of the present invention are not limited to the above-described object, and other objects that are not described will be able to be clearly understood by those skilled in the art from the following description.

In a general aspect of the disclosure, a lidar system for a vehicle, includes: a housing disposed behind a rear surface of a grill of the vehicle in which an opening is formed and having a shaft rotatably connected to an actuator, the housing including a guide groove, a guide hole, and a sliding rail; a door configured to move along the guide groove and the guide hole, and open and close the opening; a door link which rotates along with the shaft and transmits power from the actuator to the door; a lidar module which selectively operates to slide forward and backward along the sliding rail of the housing to be exposed to an outside through the opening; and a lidar loader connecting the shaft to the lidar module to deploy the lidar module according to rotation of the shaft.

The lidar module may include a lidar, a holder to which the lidar is fixed, and a bracket supporting the holder, wherein a lower surface of the bracket may be connected to the sliding rail.

The lidar system may further include an aiming bolt and an aiming guide which correct an aiming angle of the lidar are provided on the bracket.

The lidar loader may include a first loader and a second loader that are connected at respective first ends to be mutually rotatable, wherein a second end of the first loader may be connected to the shaft, and a second end of the second loader may be connected to the bracket.

The lidar loader may have a stopper which prevents the lidar module from being pushed backward in a state in which the lidar module is deployed.

The door may have first connection protrusions protruding outward from both side surfaces thereof and second connection protrusions protruding outward from extension plates extending from the first connection protrusions to be parallel to the side surfaces, wherein the first connection protrusions move along the guide hole, and wherein the second connection protrusions move along the guide groove.

The door link may include: a rotation plate disposed on an outer surface of the housing, rotatably connected to the shaft, and having a catch groove in an outer circumferential surface thereof; a rotation link having a first extension and a second extension extending in different directions and rotatably connected to the shaft while being stacked on the rotation plate; a first connection link having a first end rotatably connected to the first extension; a second connection link having a first end rotatably connected to a second end of the first connection link; a third connection link having a first end rotatably connected to a second end of the second connection link; and a guide pin rotatably connected to the second extension, wherein a second end of the third connection link is connected to the second connection protrusion.

In a first operation section, the guide pin may be configured to maintain a structure in which one surface is caught on the catch groove and move along a trajectory of an operation groove formed in the outer surface of the housing along with the rotation plate being rotated, wherein, in a second operation section, the guide pin may be configured to be released from the catch with the catch groove to stop movement thereof and rotate only the rotation plate.

The guide pin may have a structure in which the other surface is in close contact with a partition wall disposed outside the operation groove, wherein the guide pin slides between a first end and a second end of the operation groove in the first operation section, and wherein the guide pin is released from close contact with the partition wall at a position at which the second operation section starts to rotate about the rotational shaft.

The rotation plate may have a support protrusion protruding from a surface thereof toward the rotation link, wherein the support protrusion is caught on the rotation link during a process in which the rotation plate being rotated moves from the second operation section to the first operation section and rotates the rotation link.

In another general aspect of the disclosure, a lidar device for a vehicle, includes: a lidar to detect external objects; a housing to house the lidar and adapted to be disposed behind a rear surface of a grill of the vehicle in which an opening is formed and having a shaft rotatably connected to an actuator, the housing including a guide groove, a guide hole, and a sliding rail; a door configured to move along the guide groove and the guide hole of the housing, and open and close the opening; a door link that rotates along with the shaft and transmits power from the actuator to the door; a lidar loader connecting the shaft to the housing to deploy the lidar according to the rotation of the shaft; and a controller configured to control selective movement of the lidar to slide forward and backward along the sliding rail of the housing such that the lidar is externally exposed through the opening.

The housing may include a holder to which the lidar is fixed, and a bracket supporting the holder, wherein a lower surface of the bracket is connected to the sliding rail.

The lidar device may further include an aiming bolt and an aiming guide, wherein the aiming bolt and the aiming guide are provided on the bracket to correct an aiming angle of the lidar.

The lidar loader may include a first loader and a second loader that are connected at respective first ends to be mutually rotatable, wherein a second end of the first loader is connected to the shaft, and a second end of the second loader is connected to the bracket.

The lidar loader may include a stopper which prevents the lidar from being pushed backward in a state in which the lidar is deployed.

The door may have first connection protrusions protruding outward from both side surfaces thereof and second connection protrusions protruding outward from extension plates extending from the first connection protrusions to be parallel to the side surfaces, wherein the first connection protrusions move along the guide hole, and wherein the second connection protrusions move along the guide groove.

### BRIEF DESCRIPTION OF THE DRAWINGS

FIG. 1 is a schematic view illustrating a bumper cover on which a lidar system for a vehicle is installed according to an embodiment of the present invention;

FIG. 2 is a schematic view illustrating the lidar system for a vehicle according to the embodiment of the present invention;

FIG. 3 is a schematic view illustrating a configuration of the lidar system for a vehicle according to the embodiment of the present invention;

FIG. 4 is a view illustrating an accommodation space in which a partition wall and an operation groove are provided in a side wall of a housing;

FIG. 5 is a schematic view illustrating a structure of a door;

FIGS. 6A and 6B are views illustrating a door link and a configuration of the door link, respectively;

FIGS. 7-9 are views sequentially illustrating a process of operating a door to open an opening;

FIGS. 10-12 are schematic views illustrating operation of a rotation plate and a guide pin in a first operation section and a second operation section;

FIG. 13 is a schematic view illustrating a configuration of a lidar module;

FIG. 14 is a schematic view illustrating a lidar loader connected to the lidar module;

FIG. 15 is a view illustrating a configuration of the lidar loader; and

FIG. 16 is a view illustrating the lidar module moved forward in an deployed state of the lidar loader.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being "on", "connected to," "coupled to," or "joined to" another component, element, or layer it may be directly (e.g., in contact with the other component, element, or layer) "on", "connected to," "coupled to," or "joined to" the other component, element, or layer or there may reasonably be one or more other components, elements, layers intervening therebetween. When a component, element, or layer is described as being "directly on", "directly connected to," "directly coupled to," or "directly joined" to another component, element, or layer there can be no other components, elements, or layers intervening therebetween. Likewise, expressions, for example, "between" and "immediately between" and "adjacent to" and "immediately adjacent to" may also be construed as described in the foregoing.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being "connected to," or "coupled to" another component, it may be directly "connected to," or "coupled to" the other component, or there may be one or more other components intervening therebetween. In contrast, when an element is described as being "directly connected to," or "directly coupled to" another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

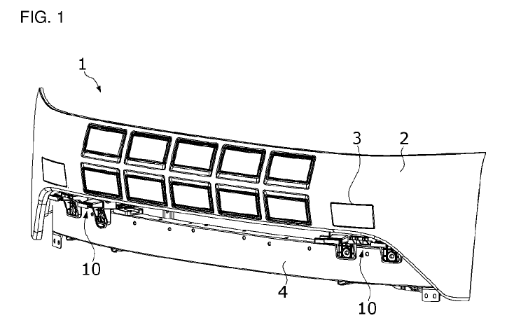

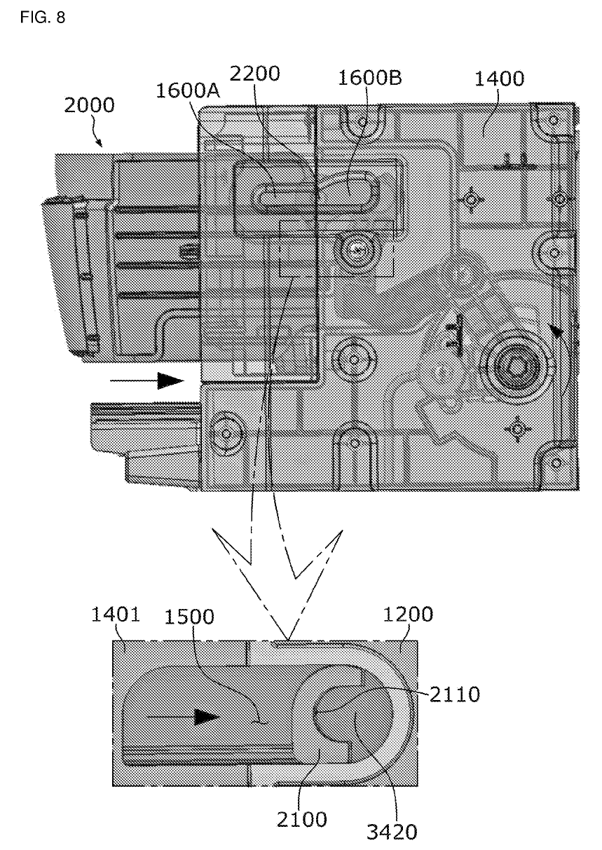

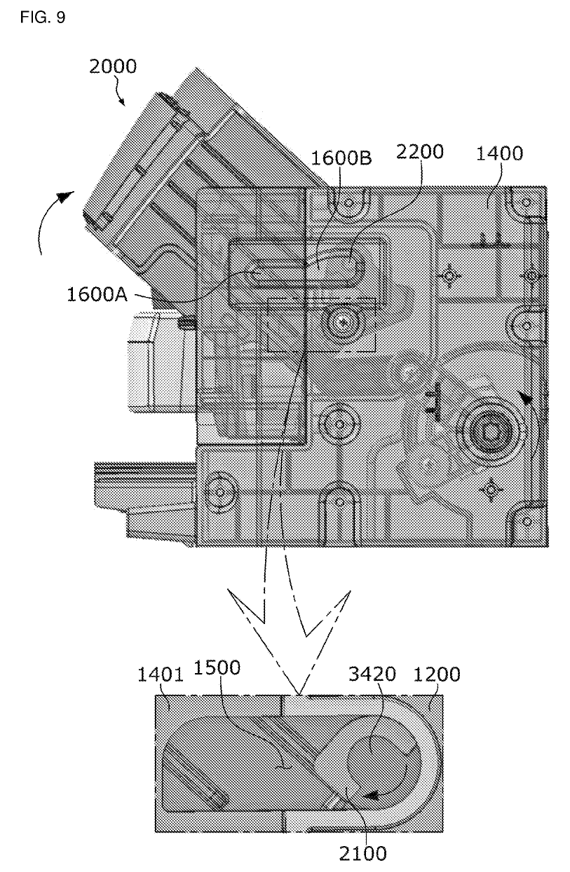

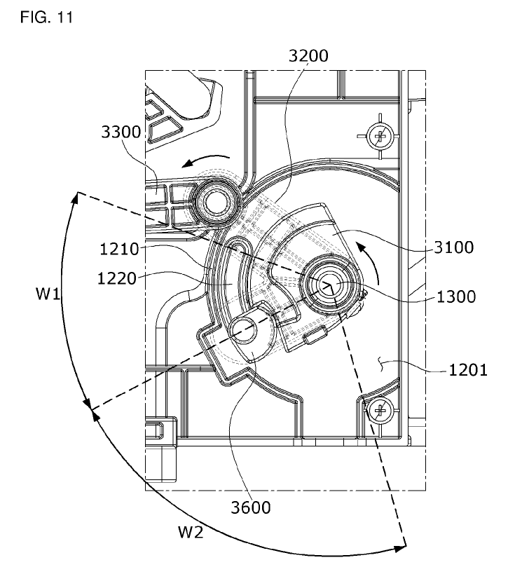

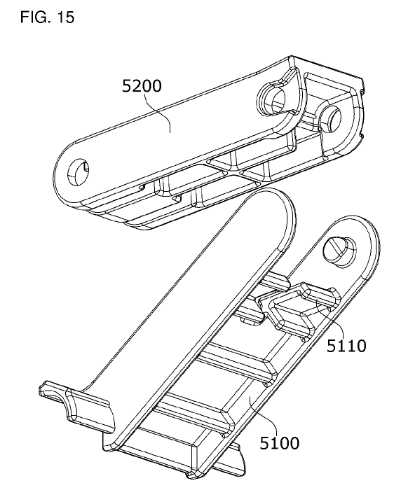

FIGS. 1-16 schematically illustrate a lidar system for a vehicle and a configuration of the lidar system for a vehicle according to embodiments of the present invention.

A lidar system 10 for a vehicle according to the embodiment of the present invention may be installed on a structure of the vehicle. For example, as illustrated in FIG. 1, the lidar system 10 may be installed on a back beam 4 located at the rear of a bumper cover 1 of the vehicle.

Referring to the drawing, the lidar system 10 for a vehicle according to the embodiment of the present invention may include a housing 1000, a door 2000, a door link 3000, a lidar module 4000, and a lidar loader 5000.

The housing 1000 may be disposed behind a rear surface of a grill 2 in which an opening 3 of the bumper cover 1 is formed and fixedly mounted on the back beam 4.

The housing 1000 may have a substantially box-shaped structure with open front and upper sides. A sliding rail 1100 extending toward a front opening 3 may be provided on a lower surface of the housing 1000 disposed on the back beam 4. In addition, a shaft 1300 may be rotatably disposed to pass through a pair of side walls 1200 of the housing 1000. The shaft 1300 may be connected to an actuator 6000 to be rotated.

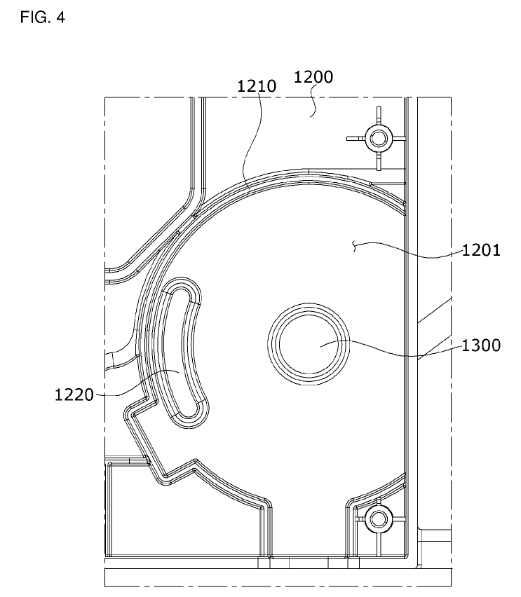

Referring to FIG. 4, an accommodation space 1201 partitioned by a partition wall 1210 may be provided at an outer surface of the side wall 1200. The partition wall 1210 may be provided in a substantially circular shape centered on the shaft 1300.

An operation groove 1220 having an arc shape with a predetermined length may be provided in the accommodation space 1201. The operation groove 1220 may be disposed adjacent to the partition wall 1210. A protruding height of the operation groove 1220 may be formed to be smaller than a height of the partition wall 1210.

A guide hole 1500 may be formed in the side wall 1200. The guide hole 1500 may be provided in a cut structure which is cut inward from the front of the side wall 1200 by a predetermined length.

A side cover 1400 may be attached to the side wall 1200 of the housing 1000 to cover the outer surface of the side wall 1200 including the accommodation space 1201. In this case, the shaft 1300 may extend to pass through the side cover 1400. In addition, an actuator 6000 may be mounted on one side of the side cover 1400.

The side cover 1400 may be spaced apart from the side wall 1200, and an internal space may be provided between the side cover 1400 and the side wall 1200 to accommodate a door link 3000 to be described below.

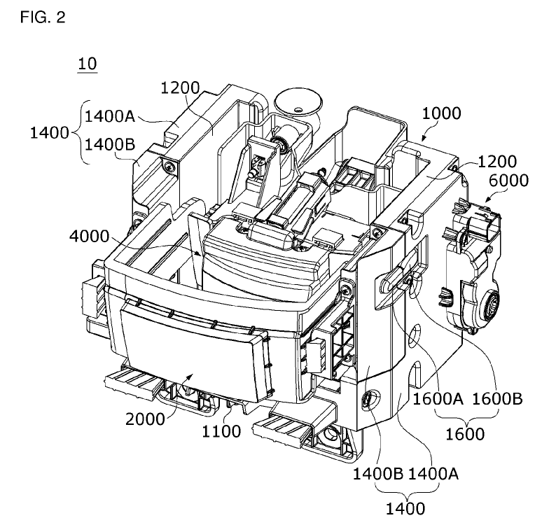

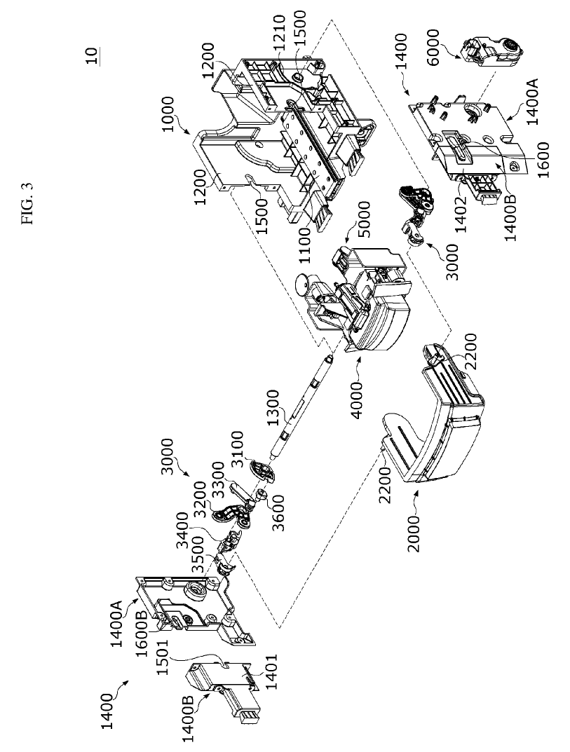

Referring to FIGS. 2 and 3, the side cover 1400 may be provided with a guide groove 1600 facing the internal space. The guide groove 1600 may be partitioned into a straight first area 1600A and a curved second area 1600B extending along a smooth curve upward from a rear end of the first area 1600A. In an embodiment, the guide groove 1600 may be located at a higher level than the guide hole 1500.

The side cover 1400 may include a first part 1400A and a second part 1400B.

The second area 1600B of the guide groove 1600 may be formed in the first part 1400A.

The second part 1400B may be attached to the front of the first part 1400A and connected to the front of the side wall 1200. Unlike the first part 1400A formed in a single-sided structure, the second part 1400B may be formed in a double-sided structure of an inner surface 1401 and an outer surface 1402. The inner surface 1401 of the second part 1400B may be connected to the side wall 1200, and the outer surface 1402 of the second part 1400B may be connected to the first part 1400A, thereby implementing a structure in which the inner surface 1401 and the outer surface 1402 are connected to continue from the side wall 1200 and the first part 1400A, respectively.

A hole 1501 connected to the guide hole 1500 of the side wall 1200 may be formed in a part of the inner surface 1401. Accordingly, in a state in which the inner surface 1401 is connected to the side wall 1200, the hole 1501 of the inner surface 1401 may be connected to the guide hole 1500 to complete the guide hole 1500 having a structure with both closed end portions.

The first area 1600A of the guide groove 1600 may be formed in the outer surface 1402. In a state in which the outer surface 1402 of the second part 1400B is connected to the first part 1400A, the first area 1600A of the outer surface 1402 may be connected to the second area 1600B of the first part 1400A to complete the guide groove 1600 having the structure with both closed end portions.

The door 2000 and the lidar module 4000 may be mounted on the housing 1000, may move in conjunction with each other, and may be alternately disposed in the opening 3. That is, when a driving mode of a vehicle is not an autonomous driving mode, the lidar module 4000 is accommodated inside the housing 1000, and the door 2000 is disposed in the opening 3 to close the opening 3, thereby preventing the lidar module 400 from being contaminated or damaged by external foreign substances. In addition, when the driving mode of the vehicle switches to the autonomous driving mode, the door 2000 opens the opening 3, and the lidar module 4000 is disposed in the opening 3 to deploy outward through the opening 3.

The door 2000 may be formed to move along the guide hole 1500 and the guide groove 1600, which are formed in the housing 1000, and selectively open or close the opening 3.

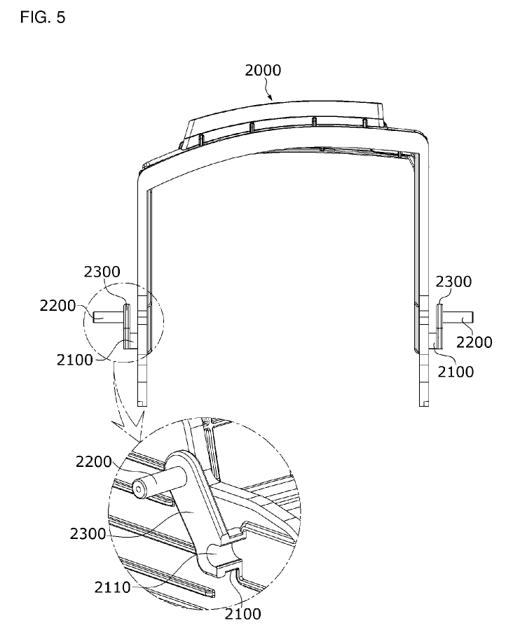

Referring to FIG. 5, the door 2000 may have first connection protrusions 2100 protruding outward from both side surfaces thereof, and second connection protrusions 2200 protruding outward from extension plates 2300 extending from the first connection protrusions 2100 to be parallel to the side surfaces. That is, the first connection protrusion 2100 may be provided to protrude from a side surface of the door 2000, and the second connection protrusion 2200 may be provided to protrude from the extension plate 2300 spaced apart from the side surface of the door 2000.

A fastening groove 2110 may be formed in the first connection protrusion 2100. The fastening groove 2110 may be formed to have a structure facing the rear of the door 2000. The extension plate 2300 may be disposed to obliquely extend from an upper end of the first connection protrusion 2100 toward an upper portion of the door 200, and the second connection protrusion 2200 may be disposed to extend outward from an end of the extension plate 2300. In an embodiment, the second connection protrusion 2200 may be located forward from the door 2000 more than the first connection protrusion 2100.

The first connection protrusion 2100 may move along the guide hole 1500 of the housing 1000, and the second connection protrusion 2200 may move along the guide groove 1600 of the housing 1000. Specifically, in a state in which the door 2000 is disposed between the side walls 1200 of the housing 1000, the first connection protrusion 2100 may be disposed to pass through the guide hole 1500. In addition, in a state in which the second connection protrusion 2200 is disposed in the internal space between the side wall 1200 and the side cover 1400 along with the extension plate 2300, the second connection protrusion 2200 may be disposed in the guide groove 1600.

Accordingly, the door 2000 may be driven to slide forward and backward and rotate along the guide hole 1500 and the guide groove 1600 in the housing 1000 through the first connection protrusion 2100 and the second connection protrusion 2200.

The door link 3000 may rotate along with the shaft 1300 and transmit power of the actuator 6000 to the door 2000. That is, the door 2000 may be driven through the door link 3000.

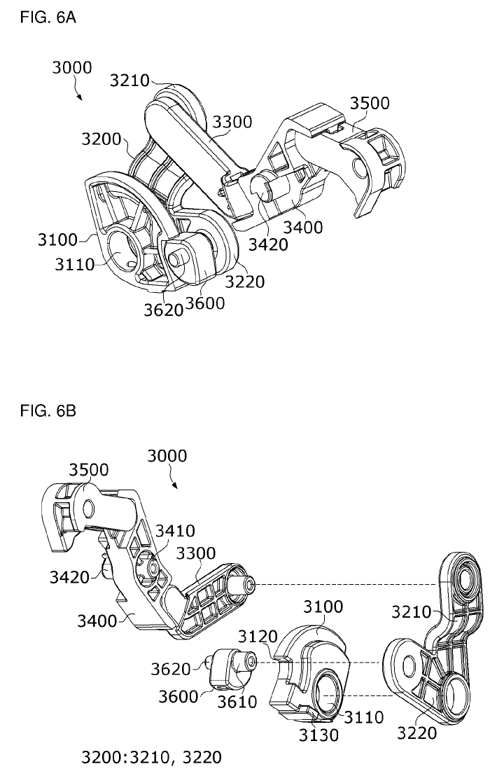

Referring to FIGS. 3 and 6, the door link 3000 may include a rotation plate 3100, a rotation link 3200, a first connection link 3300, a second connection link 3400, a third connection link 3500, and a guide pin 3600.

The rotation plate 3100 may be rotatably connected to the shaft 1300 on an outer surface of the housing 1000. Specifically, the rotation plate 3100 may have a connection hole 3110 to which the shaft 1300 is insertion-connected and may be disposed in the accommodation space 1201 provided in the side wall 1200 of the housing 1000 while connected to the shaft 1300. Accordingly, as the shaft 1300 rotates, the rotation plate 3100 may also rotate in the accommodation space 1201.

The rotation plate 3100 may have an overall quadrant shape and have a catch groove 3120 having a step structure on an outer circumferential surface thereof.

In addition, the rotation plate 3100 may have a support protrusion 3130, which protrudes toward the rotation link 3200, on a surface thereof. The support protrusion 3130 serves to rotate the rotation link 3200 along with the guide pin 3600 to be described below.

The rotation link 3200 may have a first extension 3210 and a second extension 3220, which extend in different directions, and may be rotatably connected to the shaft 1300 while stacked on the rotation plate 3100. In this case, the rotation link 3200 may not rotate integrally with the shaft 1300 but may be connected to the shaft 1300 in a structure which may be separated from the shaft 1300 to freely rotate. In an embodiment, the rotation link 3200 may have an overall V-shaped structure.

One end of the first connection link 3300 may be rotatably connected to the first extension 3210. In addition, one end of the second connection link 3400 may be rotatably connected to the other end of the first connection link 3300. In addition, one end of the third connection link 3500 may be rotatably connected to the other end of the second connection link 3400. The other end of third connection link 3500 may be rotatably connected to the second connection protrusion 2200.

Here, the second connection link 3400 connecting the first connection link 3300 to the third connection link 3500 may be rotatably connected to the side cover 1400 through a connection shaft 3410 disposed at a central portion thereof.

A fastening protrusion 3420 fastened to the fastening groove 2110 of the first connection protrusion 2100 may be provided on the connection shaft 3410. The fastening protrusion 3420 may be formed in a structure which is fitted into the fastening groove 2110, and when the first connection protrusion 2100 moves backward as the door 2000 slides backward, the fastening groove 2110 may be engaged and coupled with the fastening protrusion 3420.

In this way, when the rotation link 3200 rotates, the first connection link 3300, the second connection link 3400, and the third connection link 3500 are formed to be mutually linked to move the door 2000.

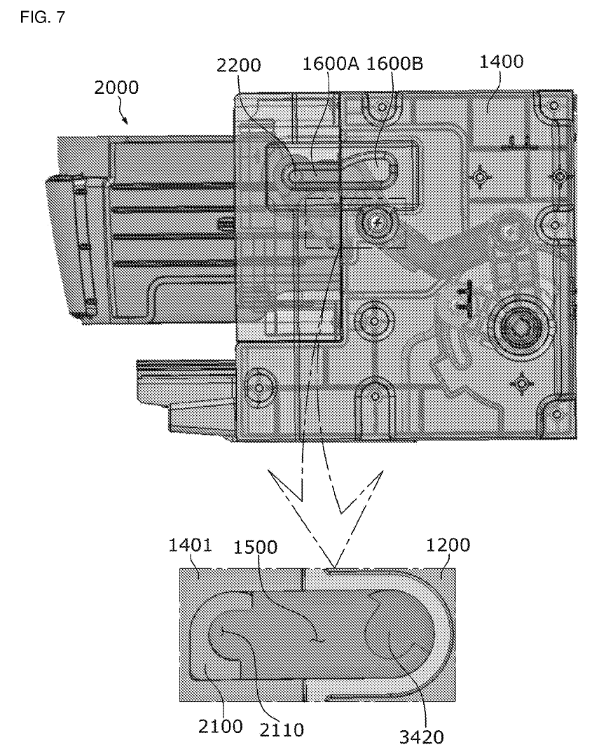

As illustrated in FIGS. 7-9, in a state in which the door 2000 closes the opening 3, when the rotation link 3200 rotates downward, the second connection link 3400 is rotated about the connection shaft 3410 in a direction opposite to that of the rotation link 3200 by the first connection link 3300, and the third connection link 3500 is moved backward by the second connection link 3400 to move the door 2000 backward.

In this case, in the door 2000, the first connection protrusion 2100 linearly moves backward along the guide hole 1500 so that the fastening groove 2110 is fastened to the fastening protrusion 3420, and the second fastening protrusion 2200 linearly moves along the first area 1600A of the guide groove 1600 along with the third connection link 3500. In addition, the first connection protrusion 2100 rotates along the connection shaft 3410 which rotates in a state in which the fastening groove 2110 is fastened to the fastening protrusion 3420, and the second connection protrusion 2200 is moved along the second area 1600B by the third connection link 3500.

In this way, the door 2000 operates with a two-way open mechanism which performs curved movement completely opening the opening 3 by primarily linearly moving backward along the first area 1600A of the guide hole 1500 and the guide groove 1600 and secondarily, coupling the first connection protrusion 2100 to the connection shaft 3410 at a rear end of the guide hole 1500 to rotate using the connection shaft 3410 as a rotational axis and at the same time, moving the second connection protrusion 2200 upward in an arc shape along the second area 1600B of the guide groove 1600.

Meanwhile, when the rotation link 3200 rotates upward, the door link 3000 operates in the reverse order, and the door 2000 performs curved movement downward and then linearly moves forward to close the door 2000.

Referring to FIGS. 3 and 6, the guide pin 3600 may be rotatably connected to the second extension 3220 of the rotation link 3200.

The guide pin 3600 may be provided in a plate structure having a substantially quadrant shape and may have rotational shafts 3610 and 3620 extending to upper and lower surfaces thereof, respectively.

The guide pin 3600 and the rotation plate 3100 may be disposed in the accommodation space 1201 of the side wall 1200. Specifically, in the accommodation space 1201, the guide pin 3600 may be disposed to have a structure in which the rotational shaft 3620 extending to the lower surface thereof is disposed in the operation groove 1220 and the rotational shaft 3610 extending to the upper surface thereof is connected to the second extension 3220.

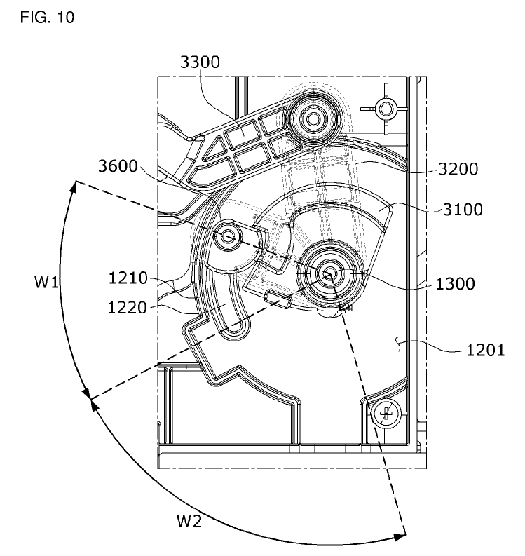

As illustrated in FIGS. 10-12, one surface of the guide pin 3600 may be selectively engaged with or disengaged from the catch groove 3120 of the rotation plate 3100 as the rotation plate 3100 rotates. That is, in a first operation section W1, the guide pin 3600 may maintain a structure which is caught on the catch groove 3120 of the rotation plate 3100, and in a second operation section W2, may be released from the catch with the catch groove 3120. The first operation section and the second operation section may correspond to sections in which the shaft is rotated. That is, the shaft may be rotated from the first operation section to the second operation section and then rotated from the second operation section to the first operation section.

Specifically, in the first operation section W1, the guide pin 3600 may maintain the structure in which one surface is caught on the catch groove 3120 and move along a trajectory of the operation groove 1220 along with the rotating rotation plate 3100. In this case, the guide pin 3600 has a structure in which the other surface is in close contact with the partition wall 1210 disposed outside the operation groove 1220, and the rotational shaft 3620 slides between one end and the other end of the operation groove 1220.

That is, when the rotation plate 3100 rotates downward, the guide pin 3600 of which one surface is caught on the catch groove 3120 is moved downward from an initial position along the trajectory of the operation groove 1220 by a force applied downward. In this case, the guide pin 3600 cannot be rotated due to interference with the partition wall 1210 and slides from one end to the other end of the operation groove 1220.

In addition, as the guide pin 3600 moves downward along the operation groove 1220, the rotation link 3200 connected to the guide pin 3600 rotates about the shaft 1300 downward.

At a position at which the second operation section W2 starts, the guide pin 3600 is released from the close contact with the partition wall 1210 and rotates about the rotational shaft 3620 outward from the rotation plate 3100. Accordingly, in the second operation section W2, the guide pin 3600 is released from the catch with the catch groove 3120 to stop movement thereof, and only the rotation plate 3100 rotates further downward.

In addition, as the guide pin 3600 stops moving downward, the rotation link 3200 connected to the guide pin 3600 also stops rotating downward.

Meanwhile, when the shaft 1300 rotates reversely, the rotation plate 3100 connected to the shaft 1300 rotates upward to the position at which the first operation section W1 starts. In addition, at the position at which the first operation section W1 starts, the rotation link 3200 is caught on the support protrusion 3130 of the rotation plate 3100 to rotate upward along with the rotation plate 3100 which rotates upward. That is, the support protrusion 3130 is caught and connected with the rotation link 3200 during the process in which the rotation plate 3100 rotates from the second operation section W2 to the first operation section W1 to rotate the rotation link 3200. In addition, the guide pin 3600 connected to the rotation link 3200 also slides upward along the operation groove 1220 to the initial position.

In this way, the guide pin 3600 is formed to move along the operation groove 1220 only in the first operation section W1 in connection with the rotating rotation plate 3100, and thus the rotation link 3200 also rotates only in the first operation section W1. Accordingly, the door 2000 may operate in the first operation section W1 to open or close the opening 3 and maintain in a stationary state without operating in the second operation section W2 (see FIGS. 7-9).

The lidar module 4000 may selectively operate to slide forward and backward along the sliding rail 1100 of the housing 1000 to be exposed to the outside through the opening 3.

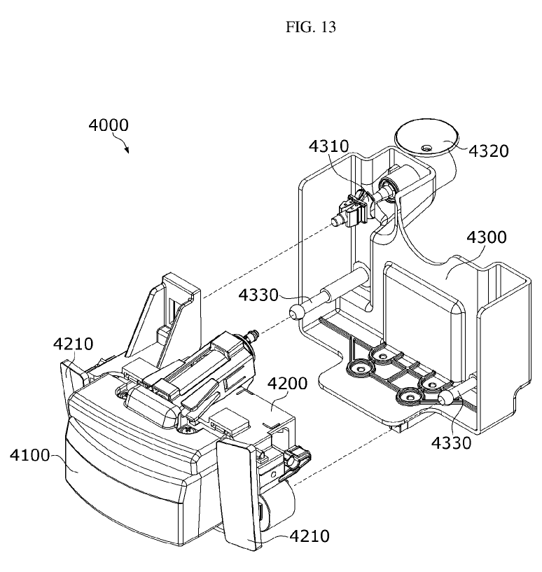

Referring to FIG. 13, the lidar module 4000 may include a lidar 4100, a holder 4200 to which the lidar 4100 is fixed, and a bracket 4300 supporting the holder 4200.

The holder 4200 may be provided with a bumper 4210 in contact with a rear surface of the grill 2 to cushion an impact while the lidar 4100 is deployed outward through the opening 3.

A lower surface of the bracket 4300 may be connected to the sliding rail 1100 to slide forward and backward along the sliding rail 1100.

The bracket 4300 may be provided with an aiming bolt 4310 and an aiming guide 4320 which correct an aiming angle of the lidar 4100. In addition, a pin bracket 4330 connected to the holder 4200 may be provided.

In an embodiment, the aiming bolt 4310 and the aiming guide 4320 may be installed on an upper portion of the bracket 4300. Accordingly, even in a state in which the door 2000 is reclined, the aiming bolt 4310 and the aiming guide 4320 are not covered by the door 2000 to be accessed. The pin bracket 4330 may be installed on a lower portion of the bracket 4300.

The aiming bolt 4310 may be mounted on the bracket 4300 in a structure in which a front end is connected to the holder 4200 and a rear end is connected to the aiming guide 4320. In addition, by manipulating an aiming tool (not illustrated) entering the aiming guide 4320, the aiming bolt 4310 adjusts an angle of the holder 4200 to correct the aiming angle of the lidar 4100.

The lidar loader 5000 may connect the shaft 1300 to the lidar module 4000 and transmit the power of the actuator 6000 to the lidar module 4000. The lidar module 4000 slides forward and backward by the power transmitted through the lidar loader 5000.

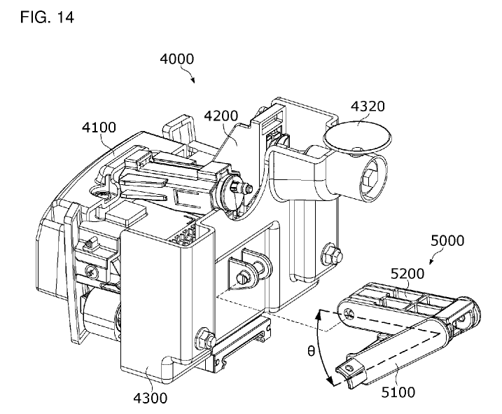

Referring to FIGS. 14-16, the lidar loader 5000 may include a first loader 5100 and a second loader 5200 of which one ends are connected to be mutually rotatable. In a state in which the one end of the first loader 5100 is connected to the one end of the second loader 5200, the other end of the first loader 5100 may be connected to the shaft 1300, and the other end of the second loader 5200 may be connected to the bracket 4300.

The first loader 5100 and the second loader 5200 may be changed from an initial state in which the first loader 5100 and the second loader 5200 are folded at an angle (intersecting angle) θ, which is an acute angle, to an unfolded state in which, as the shaft 1300 rotates downward, the angle θ gradually increases to form an obtuse angle. In this case, the angle θ of the first loader 5100 and the second loader 5200 may be about 185°. That is, the angle θ may be overrun from a straight angle about 5°.

The lidar module 4000 may be accommodated in the housing 1000 in the initial state of the lidar loader 5000 and move forward in the deployed state of the lidar loader 5000 to be deployed to the outside through the opening 3.

When the shaft 1300 rotates downward along the first operation section W1, the lidar loader 5000 may be deployed forward in the initial folded state and may move the lidar module 4000 forward by a predetermined distance. At this time, the door 2000 linearly moves backward along the first area 1600A of the guide hole 1500 and the guide groove 1600, rotates at the rear end of the guide hole 1500, and is disposed while lifted and reclined in an arc shape along the second area 1600B of the guide groove 1600 (see FIGS. 7-9).

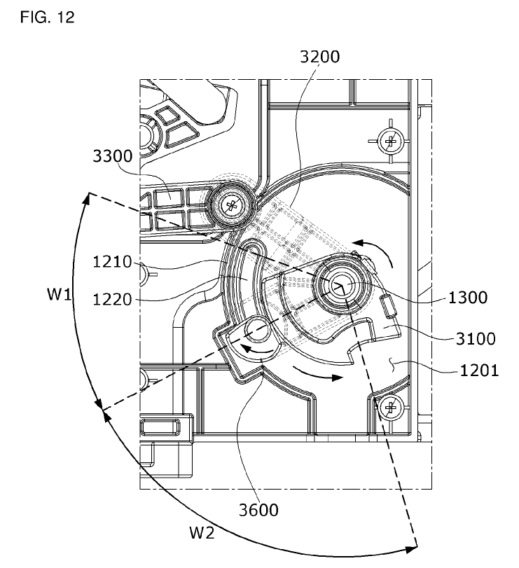

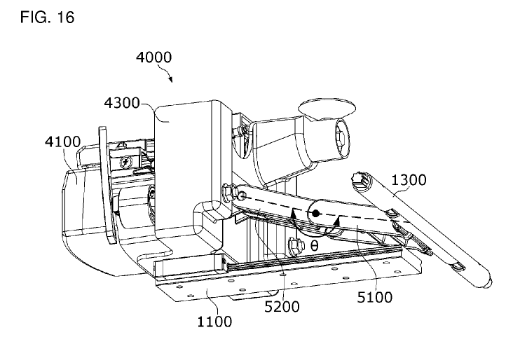

In a state in which the door 2000 is fixed in a reclined structure, when the shaft 1300 continuously rotates along the second operation section W2 as illustrated in FIG. 12, as illustrated in FIG. 16, the lidar loader 5000 is deployed forward and moves the lidar module 4000 forward to the location of the opening 3 so that the lidar 4100 passes through the opening 3 and is deployed outward.

A process of re-storing the lidar module 4000 moving outward in this way may be performed by rotating the shaft 1300 upward, that is, in a reverse direction. That is, when the shaft 1300 rotates upward along the second operation section W2 to the first operation section W1, the lidar loader 5000 is re-folded in the deployed state and moves the lidar module 4000 backward to the interior of the opening 3. Then, when the shaft 1300 continuously rotates upward along the first operation section W1, the lidar loader 5000 is folded to the initial state and accommodates the lidar module 4000 inside the housing 1000.

The door 2000 operates only in the first operation section W1 which starts after the second operation section W2 in which the lidar module 4000 moves backward from the opening 3 to the interior of the housing 1000 and thus rotates downward and moves forward without interfering with the lidar module 4000 to close the opening 3.

In an embodiment, the lidar loader 5000 may have a stopper 5110 for preventing the lidar module 4000 from being pushed backward in a deployed state of the lidar module 4000. The stopper 5110 may be provided at an inner side of a front end of the first loader 5100 to prevent the lidar loader 5000 from rotating further while in contact with a front end of the second loader 5200 in the deployed state of the lidar loader 5000. For example, the angle θ between the first loader 5100 and the second loader 5200 can be prevented from exceeding 185°.

As described above, according to the embodiment of the present invention, by forming the lidar 4100 to selectively operate to be deployed to the outside of a vehicle or accommodated inside the vehicle depending on a driving mode of the vehicle, it is possible to prevent contamination by external foreign substances from degrading the performance of the lidar 4100.

In addition, by closing the opening 3 through which the lidar 4100 moves outward in an accommodated state using the door 2000, it is possible to protect the lidar 4100 from an external environment and prevent an exterior of a vehicle from being differently felt in terms of design due to the opening of the opening 3.

In particular, by forming the door 2000 and the lidar module 4000 to operate sequentially, it is possible to effectively prevent a malfunction caused by interference occurring during the process in which the door and the lidar module 400 operate.

According to embodiments of the present invention, it is possible to prevent a lidar from being contaminated by deploying the lidar to the outside of the vehicle only when operation of the lidar is needed, such as traveling in an autonomous driving mode.

Effects of the present invention are not limited to the above-described effects, and other effects that are not described will be able to be clearly understood by those skilled in the art from the following description.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lidar system for a vehicle, comprising:
a housing disposed behind a rear surface of a grill of the vehicle in which an opening is formed and having a shaft rotatably connected to an actuator, the housing including a guide groove, a guide hole, and a sliding rail;
a door configured to:
move along the guide groove and the guide hole; and
open and close the opening;
a door link which rotates along with the shaft and transmits power from the actuator to the door;
a lidar module which selectively operates to slide forward and backward along the sliding rail of the housing to be exposed to an outside through the opening; and
a lidar loader connecting the shaft to the lidar module to deploy the lidar module according to rotation of the shaft.

2. The lidar system of claim 1, wherein the lidar module includes a lidar, a holder to which the lidar is fixed, and a bracket supporting the holder, and
wherein a lower surface of the bracket is connected to the sliding rail.

3. The lidar system of claim 2, further comprising an aiming bolt and an aiming guide which correct an aiming angle of the lidar are provided on the bracket.

4. The lidar system of claim 2, wherein the lidar loader includes a first loader and a second loader that are connected at respective first ends to be mutually rotatable, and
wherein a second end of the first loader is connected to the shaft, and a second end of the second loader is connected to the bracket.

5. The lidar system of claim 4, wherein the lidar loader has a stopper which prevents the lidar module from being pushed backward in a state in which the lidar module is deployed.

6. The lidar system of claim 1, wherein the door has first connection protrusions protruding outward from both side surfaces thereof and second connection protrusions protruding outward from extension plates extending from the first connection protrusions to be parallel to the side surfaces,
wherein the first connection protrusions move along the guide hole, and
wherein the second connection protrusions move along the guide groove.

7. The lidar system of claim 6, wherein the door link includes:
a rotation plate disposed on an outer surface of the housing, rotatably connected to the shaft, and having a catch groove in an outer circumferential surface thereof;
a rotation link having a first extension and a second extension extending in different directions and rotatably connected to the shaft while being stacked on the rotation plate;
a first connection link having a first end rotatably connected to the first extension;
a second connection link having a first end rotatably connected to a second end of the first connection link;
a third connection link having a first end rotatably connected to a second end of the second connection link; and
a guide pin rotatably connected to the second extension,
wherein a second end of the third connection link is connected to the second connection protrusion.

8. The lidar system of claim 7, wherein, in a first operation section, the guide pin is configured to maintain a structure in which one surface is caught on the catch groove and move along a trajectory of an operation groove formed in the outer surface of the housing along with the rotation plate being rotated, and
wherein, in a second operation section, the guide pin is configured to be released from the catch with the catch groove to stop movement thereof and rotate only the rotation plate.

9. The lidar system of claim 8, wherein the guide pin has a structure in which the other surface is in close contact with a partition wall disposed outside the operation groove,
wherein the guide pin slides between a first end and a second end of the operation groove in the first operation section, and
wherein the guide pin is released from close contact with the partition wall at a position at which the second operation section starts to rotate about the rotational shaft.

10. The lidar system of claim 8, wherein the rotation plate has a support protrusion protruding from a surface thereof toward the rotation link, and
wherein the support protrusion is caught on the rotation link during a process in which the rotation plate being rotated moves from the second operation section to the first operation section and rotates the rotation link.

11. A lidar device for a vehicle, the lidar device comprising:
a lidar to detect external objects;
a housing to house the lidar and adapted to be disposed behind a rear surface of a grill of the vehicle in which an opening is formed and having a shaft rotatably connected to an actuator, the housing including a guide groove, a guide hole, and a sliding rail;
a door configured to:
move along the guide groove and the guide hole of the housing; and
open and close the opening;
a door link that rotates along with the shaft and transmits power from the actuator to the door;
a lidar loader connecting the shaft to the housing to deploy the lidar according to the rotation of the shaft; and
a controller configured to control selective movement of the lidar to slide forward and backward along the sliding rail of the housing such that the lidar is externally exposed through the opening.

12. The lidar device of claim 11, wherein the housing includes a holder to which the lidar is fixed, and a bracket supporting the holder, and
wherein a lower surface of the bracket is connected to the sliding rail.

13. The lidar device of claim 12, further comprising an aiming bolt and an aiming guide,
wherein the aiming bolt and the aiming guide are provided on the bracket to correct an aiming angle of the lidar.

14. The lidar device of claim 12, wherein the lidar loader includes a first loader and a second loader that are connected at respective first ends to be mutually rotatable, and
wherein a second end of the first loader is connected to the shaft, and a second end of the second loader is connected to the bracket.

15. The lidar device of claim 14, wherein the lidar loader includes a stopper which prevents the lidar from being pushed backward in a state in which the lidar is deployed.

16. The lidar device of claim 11, wherein the door has first connection protrusions protruding outward from both side surfaces thereof and second connection protrusions protruding outward from extension plates extending from the first connection protrusions to be parallel to the side surfaces,
wherein the first connection protrusions move along the guide hole, and
wherein the second connection protrusions move along the guide groove.
